(19) United States
(12) Patent Application Publication
(10) Pub. No.: US 2007/0082184 A1
(43) Pub. Date: Apr. 12, 2007

(54) Writing paper

(76) Inventor: Olof Hansson, Hagersten (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/580,481

(22) Filed: Oct. 13, 2006

Related U.S. Application Data
(63) Continuation-in-part of application No. PCT/US06/13061, filed on Apr. 7, 2006.

(30) Foreign Application Priority Data
Apr. 13, 2005 (SE) 0500825-5

(51) Int. Cl. B41M 3/10

(52) U.S. Cl. 428/211.1

(57) ABSTRACT

The writing paper with lines includes a paper area with one or many reading or writing lines wherein the paper has a main area with a first color tone and one or many lines with a second color tone, that visibly contrast the color tone of the main area. The lines have a lighter color tone than the main area. The degree of color difference between the lines and the main area, defined as delta E in (CIE)-Lab space, is in the interval 1-18, preferably 2-10.

### PRIOR APPLICATION

This is a continuation-in-part patent application claiming priority from PCT/US06/13061, filed 7 Apr. 2006 and Swedish patent application 0500825-5, filed 13 Apr. 2005.

### FIELD OF INVENTION

The invention relates to a writing paper that includes reading or writing lines or other symbols that have a color tone that is lighter than a color tone of the background.

### BACKGROUND AND SUMMARY OF THE INVENTION

In particular, when handwritten notes are to be written on a paper sheet, it is desirable that the sheet is provided with parallel horizontal lines and possibly also vertical parallel lines to form a grid pattern such as a pattern with squares. Even when reading, it is desirable that the sheet has such lines.

When copying written text and drawings it is often less desirable that the lines are visible on the copy. On the other hand, it is desirable that the lines clearly contrast the background of the lines that are formed on the sheet surface so that the lines provide an effective support for the writer during reading and writing. On conventionally lined substantially white paper with dark lines the lines often copy better onto the copies than the notes when using conventional office copiers, fax machines and scanners.

If one tries to make the lines lightly colored, they do not fill their intended basic function i.e. to provide a support for keeping the writing on straight rows. To both provide easily visible lines and also to prevent the copying of these lines onto the copies during copying of the handwritten sheet, it is known to provide white paper sheets with relatively strong contrasting lines of a color (blue) that older conventional copiers have difficulties in recognizing. This has only a limited use since copiers, fax machines and scanners nowadays also recognize colors including blue.

One object of the invention is therefor to provide a paper with lines that provide good reading ergonomics. The object is also to provide lines that are clearly observable by the human eye but still light so that they do not easily transfer to the copies when using conventional copiers, fax machines and scanners.

The object is accomplished by the invention.

The writing paper of the present invention also solves another problem. When using conventional paper sheets that have dark symbols printed on white paper, the user cannot clearly see the user's version of the symbol compared to the pre-printed symbols since they are both dark. There is no or insufficient color difference between the user's line that is drawn on top of the dark lines of the pre-printed symbols. Even if the user is using a pen with light colors there is an insufficient color difference, a light color of such a pen does not show on top of the dark pre-printed symbols. The writing paper solves this important problem.

More particularly, the writing paper of the present invention has a background area with a first color tone. The symbols are placed on or disposed in the background area and have a second color tone. The second color tone is lighter than the first color tone of the background area. The symbols and the background area have a color difference, defined as delta E color difference in (CIE)-Lab space, being in an interval 1-18. It is also possible to use symbols with color tones that are gradually darker from the second color tone until the color tone of the last symbol is identical to the first color tone of the background area.

### BRIEF DESCRIPTION OF THE DRAWINGS

FIG. 1 is a schematic view of a writing paper of the present invention that has un-filled symbols;

FIG. 2 is a schematic view of a writing paper of the present invention that has un-filled symbols; and

FIG. 3 is a schematic view of a second embodiment of the writing paper of the present invention.

### DETAILED DESCRIPTION

The present invention basically means that the lines of the paper sheet are formed by “un-colored” paper-surface portions while the rest of the paper surface has an evenly extending and very light “coloring.” The lines represent an insignificant part of the surface area of the paper sheet. The coloring is sufficiently light so that it is not recognized by the sensor devices of conventional copiers, fax machines or scanners due to the contrast relative to the lines or relative to a reference. Because the light coloring extend over a relatively large area on the paper sheet, it can easily be recognized by the human eye as a peaceful and relaxing background while the un-colored paper areas are recognized as distinctly contrasting despite the insignificant color difference between the lines and the background i.e. the colored and the uncolored surfaces. Although the color difference between the lines is insignificant should be easily recognized it is easily recognized by the human eye even when the lines have an insignificant color difference with respect to the background (uncolored or white), while a copier with a normally set sensitivity has difficulties in recognizing that the background surface has a contrasting color relative to the lines. The sensitivity limits of copiers/scanners are normally set to a value so that dirt etc. is not shown on the copy.

### EXAMPLE OF EMBODIMENT

A white paper sheet in A4 format for typing was provided with square-shaped filled boxes with an edge length of 5 mm. The boxes were aligned in orthogonal rows and columns with a relative distance of 1 mm. The distance between the boxes thus defined a pattern of equidistant uncolored lines that were perpendicular to one another with a width of 1 mm. The color difference between the light lines and the darker portions of the sheet, i.e. delta E, in Lab-space, is in the interval 1-18, preferably in the interval 2-10.

In the lower part of the interval a conventional office copier and a conventional office scanner did not recognize any color or blackness of the boxes while the human eye could clearly recognize the lines.

The paper sheet of the present invention has substantially white lines on a paper surface wherein the remainder has a darker color tone or gray tone (having a low color difference with respect to the light line). The white lines are, in all places, recognized as more clear compared to the corresponding toned lines on the substantially white background. A drawn black line gets a clear contrasting effect on the paper of the present invention even though it is drawn on a substantially white line or on a toned background since the lines of the paper are white and the background tone of the paper are darker with a small but clearly visible color difference. In contrast hereto a drawn black line on a white paper with a toned line pattern is more difficult to recognize since the toned line on a white paper get a lower difference compared to the drawn black line compared to the toned background of the paper pattern of the present invention even when the color difference between the white paper surface and the toned part is the same in both cases.

According to the invention it seems important that the colored area is much larger than the uncolored area. For example, the uncolored lines should account for at the most 20% of the colored area.

Compared to conventional paper with dark lines on a white background the invention provides, for the human eye, a clearer contrast and more distinguished difference for a line with a substantial color difference that is drawn on the paper even if the drawn line is narrow. When copying of the paper of the invention with writings with colored lines, the writing is clearly copied while the toned background is not recognized by a conventional office copier/scanner.

Even black and white shall be seen as colors. “Paper” means a thin sheet material that is intended to used for writing purposes. A “paper sheet” does not have to include cellulose but could be based on any material with which a thin sheet product can be made that is writable.

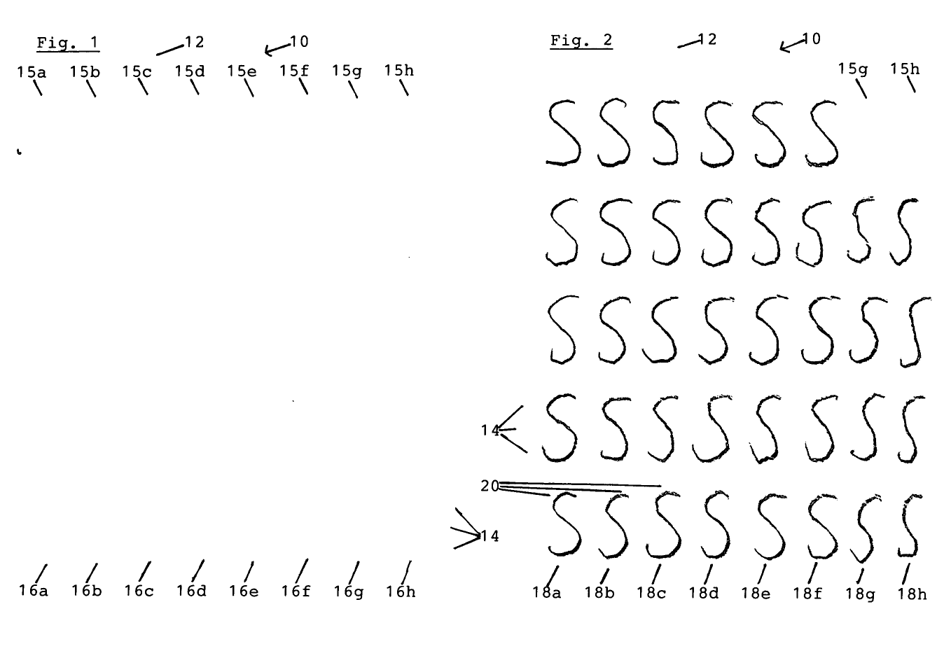

With reference to FIGS. 1-2, the writing paper 10 has a background area 12 with a first color tone. Preferably, the writing lines 14 are preferably interspersed in the background area at regular intervals. The writing lines 14 have a second color tone that is lighter than the first color tone of the background area 12.

The writing paper may include symbols 15 and/or symbols 16 and the writing lines 14 are located immediately below the symbols 15 and 16. The symbols may be letters, numbers or any other shape. The symbols 15a-15h may have the same color tone that is virtually identical to the second color tone of the writing lines 14. It is also possible that the symbols have color tones that are gradually darker. For example, the symbol 16a may have a third color tone that is very light and similar to the second color tone of the writing lines 14. The symbol 16b may have a fourth color tone, the symbol 16c a fifth color tone, the symbol 16d may have a sixth color tone and the color tones get gradually darker until the last symbol 16h. One important feature is that the color tones are gradually getting closer to the first color tone so that the color tone of the last symbol 16h on one of the writing lines 14 is identical to the second color tone of the background 12. In other words, the color tones of the symbols become gradually darker so that the last symbol is virtually identical to the second color tone. Preferably, the color tones of the symbols are not darker than the first color tone of the background area 12. However, it is possible to use symbols with color tones that are darker than the background area. Preferably, the color difference between the first and second color tones may be delta E 1-18 or any other suitable color difference.

FIG. 2 shows the writing paper 10 with the symbols filled in with dark lines by a user. In this way, the writing paper 10 could be used, for example, as a training tool for children and others that are learning to write symbols such as letters. Because the symbol 16a has a color tone that is both lighter than the first color tone of the background area 12 and the color tone of a symbol 18a that is produced, when, for example, using a conventional pen, the user can easily distinguish the symbol 16a relative to the background area 12. The user can also easily distinguish the dark color tone 20 of the symbol 18a-18h produced by the conventional pen relative to the first color tone of the background area 12 and relative to the third color tone of any unfilled portion of the symbols such as symbol 16a. The writing paper 10 of the present invention enables a user to clearly see how the user draws symbols 18a-18h compared to the unfilled symbols 16a-16h and relative to the background area 12. Another feature is that the user gets less and less help from the color tones of the unfilled symbols 16a-16h as they fade into the background area 12. In this way, the user may write the last symbol 18h on the background area without the assistance of the unfilled symbol 16h since the user cannot really see the symbol 16h relative to the first color tone of the background area 12.

The paper of the present invention may also be used for other applications such as architectural designs. The design of a house may be shown in white lines on the gray toned background so that the viewer may fill in sections of the white lines as desired. In this way, the entire house design may show in white or light colored lines while certain filled in section are shown more clearly. It may also be possible to use one light color tone for depicting the house and another light color tone for the lines and squares of the paper. Also, there is no need to use tools for drawing straight lines, circles, triangles etc. It is then possible to copy the drawings without showing the lines and squares of the paper and the sections of the architectural design that have not been filled in.

While the present invention has been described in accordance with preferred compositions and embodiments, it is to be understood that certain substitutions and alterations may be made thereto without departing from the spirit and scope of the following claims.

1-2. (canceled)

3. A writing paper, comprising:
a background area having a first color tone;
a plurality of symbols being disposed in the background area and having a second color tone, the second color tone being lighter than the first color tone of the background area; and
the symbols and the background area having a color difference, defined in delta E (CIE)-Lab space, being in an interval 1-18.

4. The writing paper of claim 3 wherein the writing paper has a first symbol that has the second color tone and a second symbol that has a third color tone that is darker than the second color tone but lighter than the first color tone of the background area.

5. The writing paper of claim 4 wherein the writing paper has a third symbol that has a fourth color tone that is darker than the third color tone but lighter than the first color tone.

6. The writing paper of claim 5 wherein the writing paper has a fourth symbol that has a fifth color tone and a fifth symbol that has a sixth color tone, the sixth color tone being identical to the first color tone.

7. The writing paper of claim 3 wherein the symbols have gradually darker color tones until a last color tone is identical to the first color tone of the background area.

8. The writing paper of claim 3 wherein the writing paper has a plurality of lines immediately below the symbols.

9. The writing paper of claim 8 wherein the lines have a color tone that is identical to the first color tone.

10. A method of using a writing paper by a user, comprising:
providing a writing paper having a background area with a first color tone and a plurality of symbols shown in the background area, the symbols having color tones that are lighter than the first color tone;
the user drawing a line inside one of the symbols, the drawn line having a dark color tone darker than both the first color tone of the background area and the color tones of the symbols; and
the user drawing a line in a first symbol to follow a shape of the first symbol.

11. The method according to claim 10 wherein the method further comprises the user filling the first symbol with the dark color tone.

12. The method according to claim 10 wherein the method further comprises providing the symbols with color tones that are gradually darker so that a color tone of a last symbol is identical to the first color tone, the user filling in all symbols with the dark color tone.

13. The method according to claim 12 wherein the method further comprises the user writing the last symbol although the last symbol cannot be seen relative to the first color tone of the background area.
